(19) United States
(12) Patent Application Publication
(10) Pub. No.: US 2007/0293261 A1
(43) Pub. Date: Dec. 20, 2007

(54) DUAL PURPOSE MOBILE DEVICE USINGULTRA WIDE BAND COMMUNICATIONS

(76) Inventor: Woo Cheol CHUNG, San Diego, CA (US)

Correspondence Address: QUALCOMM INCORPORATED, 5775 MOREHOUSE DR., SAN DIEGO, CA, 92121, US

(21) Appl. No.: 11/424,204

(22) Filed: Jun. 14, 2006

(51) Int. Cl. H04M 1/00

(52) U.S. Cl. 455/550.1

(57) ABSTRACT

A mobile phone, such as a personal cellular telephone, includes a pointer movement mechanism and a UWB transmitter. The pointer movement mechanism detects instructions issued by a user to move a graphical pointer or cursor. The UWB transmitter transmits signals that implement those instructions to a UWB receiver coupled to a computer system. In this manner, the mobile phone can be used as a relatively long-range wireless pointing device for the computer system.

### BACKGROUND OF THE INVENTION

1. Technical Field

The invention relates to the area of digital computing, and more particularly to the area of wireless input devices in digital computing.

2. Background of the Art

The personal computer has become a necessary product for many people. The common user keeps contact information, financial information, calendars, and many other useful data on a personal computer. The conventional personal computer operates with a graphical interface, making its use simple and intuitive. Most graphical interfaces work best with a pointing device, such as a computer mouse, trackball, touchpad, or the like. Most pointing devices are directly connected to the computer by design. In some cases, pointing devices incorporate radio frequency (“RF”) or infrared technology to enable wireless use. However, wireless devices are most commonly used today simply to reduce the clutter of wires that drape from the work surface down to the computer. Because of that, the wireless technologies in use are of limited range, typically not more than about four or five feet.

Personal mobile devices are becoming so commonplace that many users have become dependent on them. Modern technology has evolved to the point that many personal mobile devices are more powerful and feature-rich than a conventional computer system of years past. Mobile device manufacturers and designers are constantly searching for new ways to make mobile devices more useful to consumers. New and useful ways to take advantage of the computing power of mobile devices is always of interest to the industry.

### SUMMARY OF THE INVENTION

The invention is directed at the use of a personal mobile device as a wireless mouse that transmits in the ultra-wideband (“UWB”) frequency spectrum. Briefly stated, a mobile device is adapted to function as a wireless mouse. A wireless transmitter is included that transmits signals that correspond to intended movements of a pointer or cursor on a graphical user interface. The wireless transmitter is configured to operate in the UWB frequency spectrum. Advantageously, by operating in the UWB frequency spectrum, the mobile device can be used as a pointing device at much larger distances than conventional wireless pointing devices without interfering with other electronic devices. This added benefit is useful in certain situations, such as while giving a presentation or the like.

In one aspect, the invention provides a mobile device including computer-executable components. The computer-executable components include a phone manager configured to handle phone calls made by and/or to the mobile device; an ultra-wideband transceiver for transmitting signals in accordance with a Wireless Universal Serial Bus (“W-USB”) standard; and a pointer manager configured to detect an input instruction related to a pointer movement and to cause a signal based on the input instruction to be transmitted using the ultra-wideband transceiver to a host computer.

In another aspect, the invention provides a method for communicating pointer information from a mobile device to a host computer, and a computer-readable medium encoded with instructions for performing the method. The method includes initiating a pointer mode on a mobile device; receiving an instruction pertaining to pointer movement; and transmitting a signal associated with the instruction to the host computer using an ultra-wideband universal serial bus transmitter.

In yet another aspect, the invention provides a method for switching between modes of operation on a mobile device, and a computer-readable medium encoded with instructions for performing the method. The method includes initiating a pointer mode on the mobile device; detecting an incoming phone call on the mobile device; switching the mobile device from the pointer mode to a normal mode, the normal mode being operative to handle phone calls on the mobile device; and handling the phone call on the mobile device.

### BRIEF DESCRIPTION OF THE DRAWINGS

FIG. 1 is a conceptual overview of a mobile device configured in accordance with one implementation of the invention interacting with other computing systems.

FIG. 2 is a graphical illustration of another embodiment of the mobile device introduced above in connection with FIG. 1.

FIG. 3 is a functional block diagram generally illustrating components of a mobile device constructed in accordance with the teachings of the present invention.

FIG. 4 is a functional block diagram generally illustrating core components of a sample mobile device in which implementations of the invention are particularly applicable.

FIG. 5 is an operational flow diagram generally illustrating steps performed by a process for communicating pointer information from a mobile device to a host computer.

FIG. 6 is an operational flow diagram generally illustrating steps performed by a process executing on a mobile device for switching between modes of operation.

### DETAILED DESCRIPTION OF CERTAIN EMBODIMENTS

Briefly stated, the invention may be embodied in one instance in a mobile device, such as a personal cellular telephone, that includes a pointer movement mechanism and a UWB transmitter. The pointer movement mechanism detects instructions issued by a user to move a graphical pointer or cursor. The UWB transmitter transmits signals that implement those instructions to a UWB receiver coupled to a computer system. In this manner, the mobile phone can be used as a wireless pointing device for the computer system.

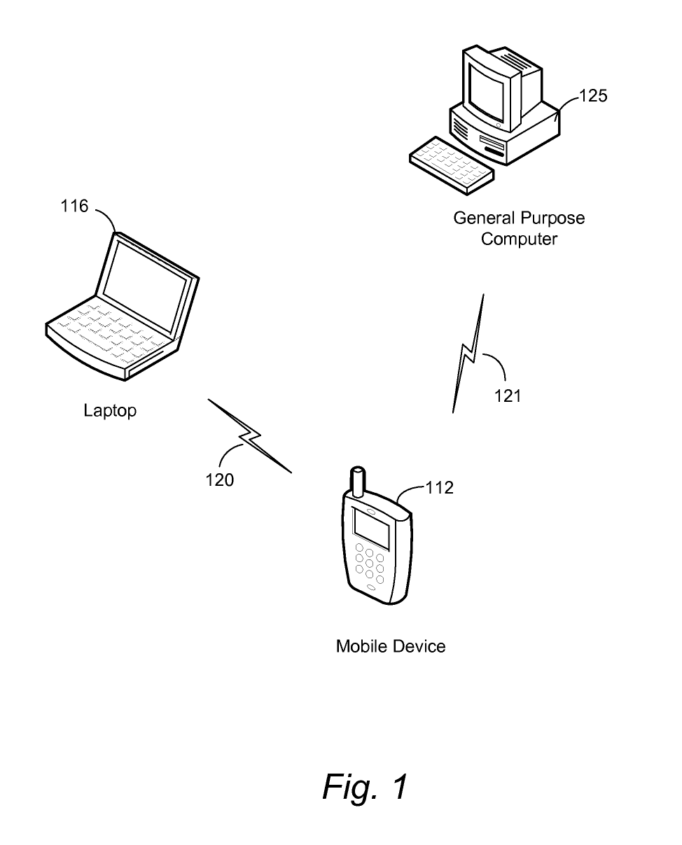

FIG. 1 is a conceptual overview of a mobile device 112 configured in accordance with one implementation of the invention interacting with other computing systems. In this example, the mobile device 112 is in wireless communication with a host computing device, such as a laptop computer 116 or a general purpose computer 125. The mobile device 112 is configured to detect input instructions provided by a user in much the same manner as a conventional input device, such as a computer mouse, trackball, or touchpad. The mobile device 112 then transmits those input instructions as signals over a wireless link to the host computing device.

In this implementation, the mobile device 112 and the host computer preferably communicate using a wireless Universal Serial Bus (“USB”) interface. More specifically, in accordance with this preferred implementation of the invention, the mobile device 112 and the host computer, such as the laptop 116 or the general purpose computer 125, communicate using an Ultra-WideBand (“UWB”) wireless USB link 120, 121. Unlike conventional wireless communications, the UWB USB link 120, 121 enables greater distances and throughput between the mobile device 112 and the host computer. Throughout this document, the terms “wireless USB”, “Ultra-WideBand USB”, and “UWB USB” may be used interchangeably.

There have been developments in the area of ultra wideband (UWB) technology largely driven by the wireless personal area network (WPAN) concept. The Institute of Electrical and Electronics Engineers (“IEEE”) formulated a basis for WPANs using UWB (See IEEE802.15.3a). Currently, industry organizations in the USB area, such as the USB implementers Forum (“USB-IF”) are considering the use of UWB for wireless USB, and the “Certified Wireless USB” will support robust high-speed wireless connectivity using the common multiband OFDM based UWB radio platform.

In 2002, the Federal Communications Commission approved the limited use of the ultra wide bandwidth of 7.5 GHz over the frequency band of 3.1-10.6 GHz for commercial use. Since then, two approaches for implementing this new radio technology are emerging: (1) an impulse-based approach, and (2) a multiband OFDM based approach. Embodiments of the invention may be implemented and deployed based on these two approaches or other alternative radio technologies.

UWB USB promises data rates comparable to the USB 2.0 specification—480 Mbps—at 3 meters distance, and may even provide more than 1 Gbps. UWB is particularly well suited to applications that benefit from high data rates over short-range wireless. Thus, UWB USB is particularly well suited to the prospective uses of mobile devices, such as streaming video. Accordingly, the inventor has determined that basing implementations of the invention on the emerging UWB USB technology has advantages that, until now, have remained unrealized.

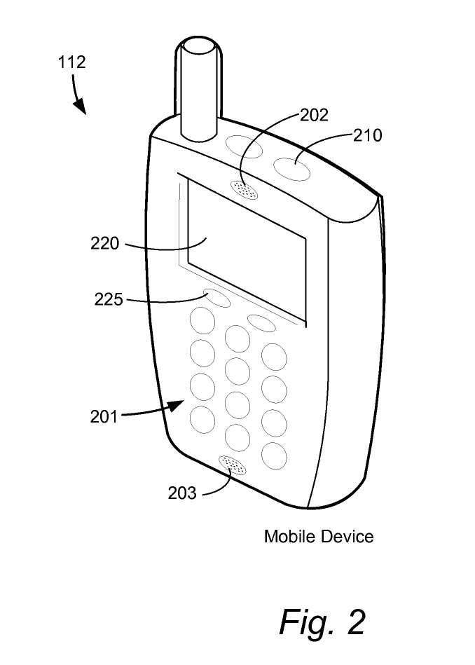

FIG. 2 is a graphical illustration of another embodiment of the mobile device 112 introduced above in connection with FIG. 1. As mentioned above, the mobile device 112 could be any one of many different types of portable or handheld devices, such as cell phones, personal music players, Personal Digital Assistants (“PDAs”), Global Positioning System (“GPS”) receivers, and the like. In this particular implementation, the mobile device 112 is a cellular phone adapted in accordance with the teachings of the present invention. More specifically, the mobile device 112 includes a wireless interface to a host computer, particularly implemented using UWB USB.

In short, the functionality of a conventional mobile device, such as a cell phone, is combined with the functionality of a conventional computer input mechanism, such as a mouse. In one implementation, the combination results in the mobile device 112 illustrated in FIG. 2. As shown, the mobile device 112 includes the components of a mobile device, such as a keypad 201, earpiece 202, a microphone 203, and a display 220. In addition, the mobile device 112 includes components of a pointing device, such as selection buttons 210 and a movement detection mechanism. Different embodiments can implement various mechanisms for detecting movement, such as a roller ball or optical LED (not shown).

The mobile device 112 of this embodiment is configured to operate in any one or more of the following three modes:

1. Normal Mode. In this mode, the mobile device 112 operates in a conventional manner in accordance with its primary functionality. In this particular implementation, the mobile device 112 operates as a cellular phone. Accordingly, normal mode can be initiated by a phone call from or to the mobile device 112. For other implementations, normal mode may involve the mobile device 112 performing as an MP3 player, GPS receiver, camera, or the like.

2. Pointer Mode. In this mode, the mobile device 112 operates as a pointing device, such as a mouse. Pointer mode is initiated by moving, dragging, or clicking the mouse buttons on the cover of the top of the handheld devices (e.g., flip-phone) and dedicated for mouse operations. In pointer mode, an incoming call will not interrupt and switch the mobile device 112 to normal mode.

3. Hybrid Mode. In this mode, the mobile device 112 operates in either normal mode or pointer mode, but the currently operative mode can be interrupted by an indication to switch to the other mode. For example, if the mobile device 112 is operating as a pointing device in hybrid mode when a phone call comes in, the mobile device 112 will accept the call and switch to normal operation.

Using this implementation, the overall cost of bill of materials (BOMs) can be reduced with moderate increase in hardware complexity for existing handheld devices. Conventional computer mice could become obsolete once other mobile devices begin serving dual duty. The built-in pointing devices found in many laptop computers could even be removed.

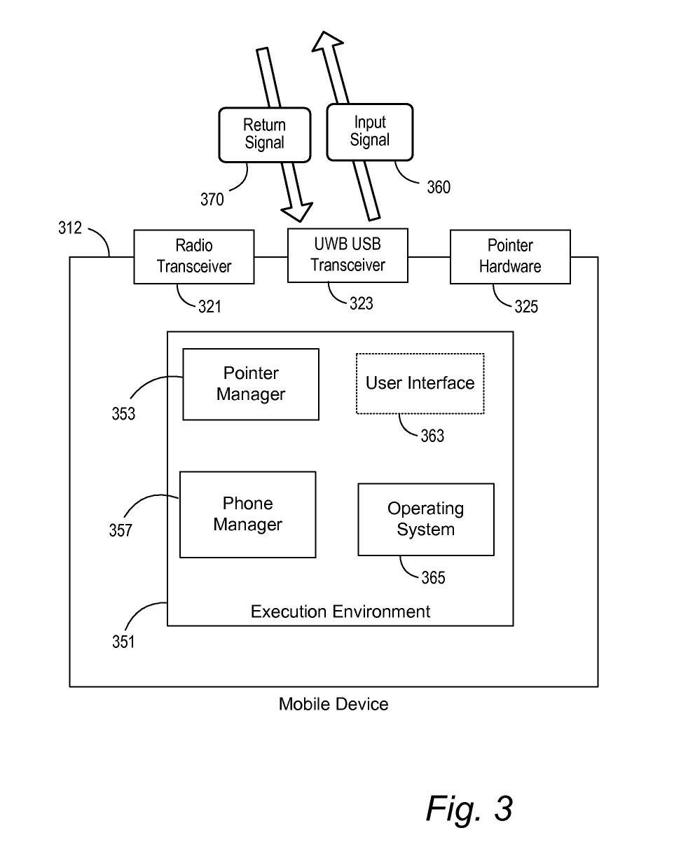

FIG. 3 is a functional block diagram generally illustrating components of a mobile device 312 constructed in accordance with the teachings of the present invention. In this implementation, the mobile device 312 includes an execution environment 351 in which computer-executable components reside, and hardware communication components. The hardware communication components include a radio transceiver 321 and a UWB USB transceiver 323. The radio transceiver 321 is configured to transmit and receive signals over a wireless telecommunications network, such as a cellular telephone network. The UWB USB transceiver 323 is configured to operate in accordance with a wireless USB convention using UWB technology. Preferably, the UWB USB transceiver 323 is configured to transmit and (optionally) receive data in the frequency band between 3.1 GHz and 10.6 GHz. The transmission protocol is compatible with the emerging wireless USB standard.

Pointer hardware 325 is included to accept user input in the form of movement instructions. The pointer hardware 325 could be any conventional components or circuitry for detecting movement or instructions that correspond to the movement of a pointer on a graphical user interface. Examples of the pointer hardware 325 include optical sensors, mechanical wheels driven by a roller ball, gyroscopic sensors, or the like. The pointer hardware 325 is incorporated in the mobile device 312 in such a manner as to retain the general form factor of the mobile device 312.

The mobile device 312 also includes an execution environment 351 in which software components reside and execute. The software components used in this implementation include a pointer manager 353 and a phone manager 357. The phone manager 357 is a component responsible for managing and controlling the operations of the mobile device 312 when operating in normal mode, such as when making and/or receiving phone calls. The phone manager 357 interfaces with the radio transceiver 321 to transmit and receive data signals during normal mode operation, such as when making and receiving phone calls.

A pointer manager 353 is a component responsible for managing and controlling pointer functions incorporated in the mobile device 312. For instance, the pointer manager 353 receives signals from the pointer hardware 325 that indicates an intended movement. The pointer manager 353 then transmits those signals (input signal 360) using the UWB USB transceiver 323 to a host computer. In addition, the pointer manager 353 may optionally receive a return signal 370 from the host computer.

The execution environment 351 also includes an operating system 365 that controls the execution of the other components in the execution environment 351 as well as the interaction of those components with the several hardware components. A user interface 363 may optionally be included to control the display of information on a display.

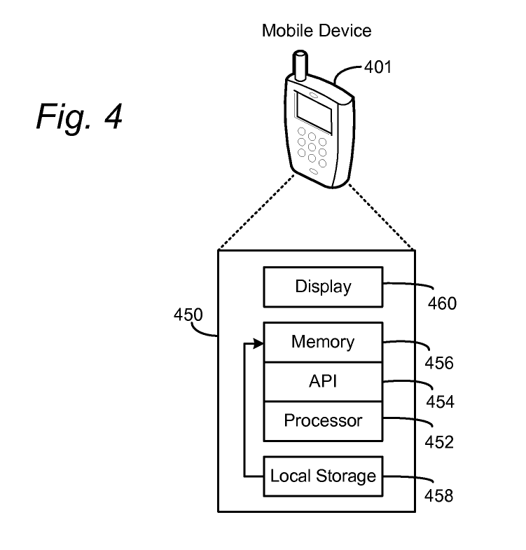

FIG. 4 is a functional block diagram generally illustrating core components of a sample mobile device 401 in which implementations of the invention are particularly applicable. The mobile device 401 could be any device having computing functionality, such as a cellular telephone, a personal digital assistant, a handheld “palmtop” device, a portable music player, a portable voice recorder, a GPS receiver, or the like.

The mobile device 401 has a computer platform 450 that can receive and execute software applications, display data, and receive input. The computer platform 450 includes a processor 452, such as an application-specific integrated circuit (“ASIC”), digital signal processor (“DSP”), microprocessor, microcontroller, logic circuit, state machine, or other data processing device. The processor 452 executes the application programming interface (“API”) layer 454 that interfaces with any resident programs in the memory 456 of the mobile device. The memory 456 can include random-access or read-only memory (RAM or ROM), EPROM, EEPROM, flash memory, or any memory common to computer platforms. The computer platform 450 also includes a local storage 458 that can hold software applications, files, or data not actively used in memory 456, such as the components of the system illustrated in FIG. 3. The local storage 458 is typically comprised of one or more flash memory cells, but can be any secondary or tertiary storage device as known in the art, such as magnetic media, EPROM, EEPROM, optical media, tape, or soft or hard disk.

The computer platform 450 also includes a display 460 that may be used by the software applications to display data. The display 460 may optionally include touch sensitive capability. Various user interfaces (e.g., user interface 363) may be rendered on the display 460.

The components shown in FIG. 4 are typical of many types of mobile devices, but it will be appreciated that other components may be added to the mobile device 401 and in certain rare cases, some components shown in FIG. 4 may be omitted from the mobile device 401.

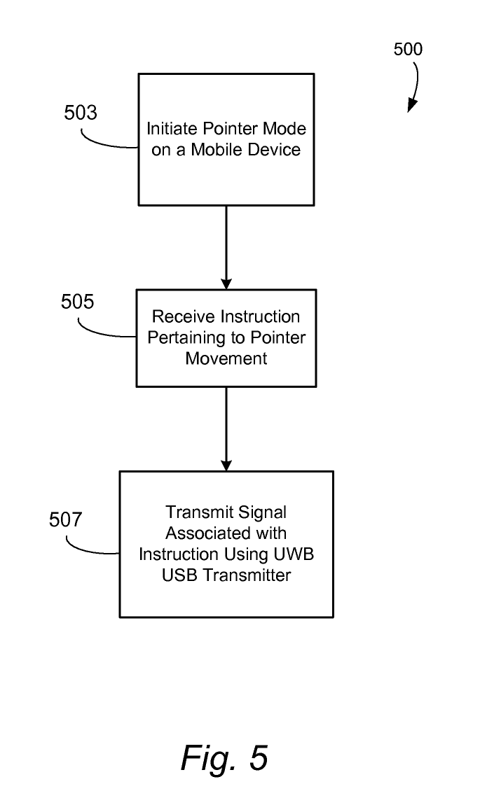

FIG. 5 is an operational flow diagram generally illustrating steps performed by a process for communicating pointer information from a mobile device to a host computer. The process 500 may be implemented on a mobile device constructed substantially as described above in conjunction with FIGS. 1 through 4. The process begins at step 503.

At step 503, a pointer mode is initiated on a mobile device. The pointer mode is a mode of operation in which the mobile device may receive instructions related to input, more specifically related to spatial movement as a form of input.

At step 505, an instruction pertaining to pointer movement is received. The instruction may comprise user input detected through a motion detection mechanism, such as a mechanical, gyroscopic, or optical detection mechanism. In such a case, the instruction may include an indication to move a pointer on a graphical user interface in one or another direction.

At step 507, a signal associated with the instruction received at step 505 is transmitted to a host computer using a UWB USB transmitter. In this implementation, the signal is transmitted using a wireless protocol that is compliant with the wireless USB standard. The signal, once received by a host computer, is used to control a pointer or other aspect of a graphical user interface or a graphical execution environment.

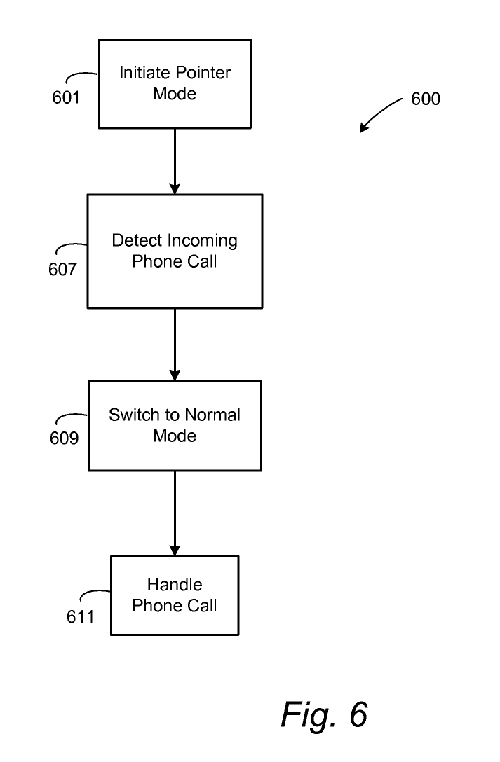

FIG. 6 is an operational flow diagram generally illustrating steps performed by a process executing on a mobile device for switching between modes of operation. The process 600 may be implemented on a mobile device constructed substantially as described above in conjunction with FIGS. 1 through 4. The process begins at step 601.

At step 601, a pointer mode is initiated on the mobile device. The pointer mode is a mode of operation in which the mobile device may receive instructions related to input, more specifically related to spatial movement as a form of input.

At step 607, an incoming phone call is detected on the mobile device. In this implementation, the mobile device is capable of receiving and making phone calls. In other implementations, the mobile device may be capable of playing sound files, such as MP3s or the like. In those other implementations, rather than an incoming phone call, the mobile device may detect an instruction to begin playing an audio file, or the like. Many other examples will also become apparent.

At step 609, the mobile device switches from pointer mode to normal mode. In accordance with this implementation of the invention, the mobile device is capable of operating in a normal mode, in which phone calls can be received and transmitted, and in the pointer mode. Upon detecting the incoming phone call (or the like) at step 607, the mobile device switches from pointer mode to normal mode.

At step 611, the phone call is handled. In accordance with this implementation, while the phone call is being handled, the mobile device is incapable of operating in pointer mode. In other implementations, the mobile device may be used in both normal mode and pointer mode simultaneously. In yet other implementations, the mobile device may switch back from normal mode to pointer mode based on the occurrence of an event consistent with a pointer movement or an input related to a requested pointer movement.

While the present invention has been described with reference to particular embodiments and implementations, it should be understood that these are illustrative only, and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A mobile device including computer-executable components, comprising:
a phone manager configured to handle phone calls made by and/or to the mobile device;
an ultra-wideband transceiver for transmitting/receiving signals in accordance with a Wireless Universal Serial Bus (“W-USB”) standard; and
a pointer manager configured to detect an input instruction related to a pointer movement and to cause a signal based on the input instruction to be transmitted using the ultra-wideband transceiver to a host computer.

2. The mobile device recited in claim 1, wherein the phone manager is further configured to instruct the pointer manager to terminate a pointer mode upon a phone call event occurring.

3. The mobile device recited in claim 2, wherein the phone call event comprises an incoming phone call or an event indicating an initiation of an outgoing phone call.

4. The mobile device recited in claim 1, wherein the ultra-wideband transceiver is further configured to operate in one or more frequency bands from approximately 3 GHz to approximately 11 GHz.

5. The mobile device recited in claim 4, wherein the frequency band of operation comprises a bandwidth of 7.5 GHz or any ultra wideband range.

6. The mobile device recited in claim 1, wherein the pointer manager is further configured to terminate a pointer mode upon an indication that a phone call event has occurred.

7. The mobile device recited in claim 6, wherein the phone call event comprises an incoming phone call or an event indicating an initiation of an outgoing phone call.

8. A method for communicating pointer information from a mobile device to a host computer, comprising:
initiating a pointer mode on a mobile device;
receiving an instruction pertaining to pointer movement; and
transmitting a signal associated with the instruction to the host computer using an ultra-wideband universal serial bus transmitter.

9. The method recited in claim 8, further comprising switching the mobile device from the pointer mode to a normal mode, the normal mode being operative to handle phone calls on the mobile device.

10. The method recited in claim 9, further comprising handling the phone call on the mobile device.

11. The method recited in claim 8, wherein the signal is transmitted in a frequency band or multiple frequency bands from approximately 3 GHz to approximately 11 GHz.

12. The method recited in claim 11, wherein the frequency band comprises an operating bandwidth of approximately 7.5 GHz or any ultra wideband range.

13. A method for switching between modes of operation on a mobile device, comprising:
initiating a pointer mode on the mobile device;
detecting an incoming phone call on the mobile device;
switching the mobile device from the pointer mode to a normal mode, the normal mode being operative to handle phone calls on the mobile device; and
handling the phone call on the mobile device.

14. The method recited in claim 13, wherein the mobile device is operative, while in the pointer mode, to transmit pointing instructions to a host computer using an ultra-wideband universal serial bus transmitter.

15. The method recited in claim 14, wherein the pointing instructions are transmitted in a frequency band or multiple frequency bands from approximately 3 GHz to approximately 11 GHz.

16. The method recited in claim 15, wherein the frequency band comprises an operating bandwidth of approximately 7.5 GHz or any ultra wideband range.

17. A computer-readable medium having computer-executable instructions for communicating pointer information from a mobile device to a host computer, the instructions comprising:
initiating a pointer mode on a mobile device;
receiving an instruction pertaining to pointer movement; and
transmitting a signal associated with the instruction to the host computer using an ultra-wideband universal serial bus transmitter.

18. The computer-readable medium recited in claim 17, further comprising switching the mobile device from the pointer mode to a normal mode, the normal mode being operative to handle phone calls on the mobile device.

19. The computer-readable medium recited in claim 18, further comprising handling the phone call on the mobile device.

20. The computer-readable medium recited in claim 17, wherein the signal is transmitted in a frequency band or multiple frequency bands from approximately 3 GHz to approximately 11 GHz.

21. The method recited in claim 20, wherein the frequency band comprises an operating bandwidth of approximately 7.5 GHz or any ultra wideband range.

22. A computer-readable medium having computer-executable instructions for switching between modes of operation on a mobile device, the instructions comprising:
initiating a pointer mode on the mobile device;
detecting an incoming phone call on the mobile device;
switching the mobile device from the pointer mode to a normal mode, the normal mode being operative to handle phone calls on the mobile device; and
handling the phone call on the mobile device.

23. The computer-readable medium recited in claim 22, wherein the mobile device is operative, while in the pointer mode, to transmit pointing instructions to a host computer using an ultra-wideband universal serial bus transmitter.

24. The computer-readable medium recited in claim 23, wherein the pointing instructions are transmitted in a frequency band or multiple frequency bands from approximately 3 GHz to approximately 11 GHz.

25. The computer-readable medium recited in claim 24, wherein the frequency band comprises an operating bandwidth of approximately 7.5 GHz or any ultra wideband range.

26. A system for communicating pointer information from a mobile device to a host computer, the instructions comprising:
means for initiating a pointer mode on a mobile device;
means for receiving an instruction pertaining to pointer movement; and
means for transmitting a signal associated with the instruction to the host computer using an ultra-wideband universal serial bus transmitter.

27. A system for switching between modes of operation on a mobile device, the instructions comprising:
means for initiating a pointer mode on the mobile device;
means for detecting an incoming phone call on the mobile device;
means for switching the mobile device from the pointer mode to a normal mode, the normal mode being operative to handle phone calls on the mobile device; and
means for handling the phone call on the mobile device.
